(19) United States
(12) Patent Application Publication
(10) Pub. No.: US 2020/0126091 A1
(43) Pub. Date: Apr. 23, 2020

(54) APPARATUS FOR PAYMENT SYSTEM AND OPERATION METHOD OF PAYMENT SYSTEM

(71) Applicant: SAMSUNG ELECTRONICS CO., LTD., Suwon-si (KR)

(72) Inventors: Boram KIM, Suwon-si (KR); Sejun HAN, Suwon-si (KR); Sangeun SHIN, Suwon-si (KR); Younghyun YOO, Suwon-si (KR); Jongik JANG, Suwon-si (KR); Yoonsik CHOI, Suwon-si (KR)

(73) Assignee: SAMSUNG ELECTRONICS CO., LTD., Suwon-si (KR)

(21) Appl. No.: 16/655,519

(22) Filed: Oct. 17, 2019

(30) Foreign Application Priority Data
Oct. 17, 2018 (KR) 10-2018-0123925

(51) Int. Cl. G06Q 20/42; G06Q 20/40; G06Q 30/06

(52) U.S. Cl. CPC G06Q 20/425; G06Q 30/0635; G06Q 20/407

(57) ABSTRACT

Provided are an apparatus for a payment system and an operation method of the payment system. The operation method of the payment system may include: transmitting, to a user device based on a first order, order information including information regarding the first order and a verification module caller for verifying the order information; receiving, from the user device, a request to verify the order information using the verification module caller; obtaining, based on the received request to verify the order information, a verification result indicating whether the first order is a valid order; and transmitting the verification result to the user device.

### CROSS-REFERENCE TO RELATED APPLICATION(S)

This application is based on and claims priority under 35 U.S.C. § 119 to Korean Patent Application No. 10-2018-0123925, filed on Oct. 17, 2018, in the Korean Intellectual Property Office, the disclosure of which is incorporated by reference herein in its entirety.

### BACKGROUND

### 1. Field

The disclosure relates to an apparatus for a payment system and an operation method of the payment system, and more particularly, to an apparatus for a payment system using a plurality of devices and an operation method of the payment system.

### 2. Description of Related Art

Various services are being developed to make payment online using electronic devices, such as a mobile device, a tablet, a television (TV), and the like.

A user may proceed with payment by using a device different from a device used to request payment online. When different devices are used to request payment and proceed with the payment, there is a possibility that a duplicate payment or a payment error may occur due to a difference between the time when the payment is processed and the time when cancelation of the payment is checked using the two devices. Therefore, there is a need for a method of preventing an error in a payment system.

### SUMMARY

Provided are a method and a device for preventing an error in a payment system by additionally verifying a user's order information, when the payment system is implemented using different devices.

Also provided are a method and a device for reducing a possibility of a duplicate payment or a payment error by additionally verifying a user's order information, when a payment system is implemented using different devices, thereby reducing service operation costs incurred to respond to inquiries from customers.

Additional aspects will be set forth in part in the description which follows and, in part, will be apparent from the description, or may be learned by practice of the presented embodiments.

In accordance with an aspect of the disclosure, a method for verifying validity of an order using multiple devices includes: transmitting, to a user device based on a first order, order information including information regarding the first order and a verification module caller for verifying the order information; receiving, from the user device, a request to verify the order information using the verification module caller; obtaining, based on the received request to verify the order information, a verification result indicating whether the first order is a valid order; and transmitting the verification result to the user device.

The transmitting the verification result to the user device may include: transmitting a verification result indicating a success to the user device, based on the first order being the valid order; and transmitting a verification result indicating a failure to the user device, based on the first order not being the valid order.

The method may further include: receiving, from a payment server, a first payment result with respect to the first order; obtaining, based the first payment result, payment status information indicating whether payment for the first order is completed; and changing the payment status information to indicate completion of the payment based on the payment status information not indicating a payment completion status.

The method may further include, based on receiving the first payment result with respect to the first order from the payment server, controlling a payment request device that requested the first order to provide a notification informing about the completion of the payment.

The method may further include: receiving, from the payment server, a second payment result with respect to the first order; obtaining, based on receiving the second payment result, the payment status information with respect to the first order; and transmitting, to the payment server based on the payment status information indicating a payment completion status, a request to cancel payment corresponding to the second payment result.

The method may further include: receiving a request to cancel the first order; obtaining, based on the received request to cancel the first order, payment status information with respect to the first order; and changing, based on the payment status information not indicating a payment completion status, the payment status information to indicate a scheduled cancellation status.

The method may further include, based on receiving the request to cancel the first order, controlling a payment request device that cancels the first order to provide a notification informing that cancellation of payment is in progress.

The method may further include: receiving, from a payment server, a first payment result with respect to the first order; obtaining, based on the received first payment result, the payment status information with respect to the first order; and transmitting, to the payment server based on the obtained payment status information indicating the scheduled cancellation status, a request to cancel payment corresponding to the first payment result.

The method may further include, based on a result of cancelling the payment corresponding to the first payment result being received, controlling a notification informing about completion of cancellation of the payment to be provided.

The order information may include at least one of a unique order number, order requester information, amount information, information regarding an item ordered, and payment status information related to the first order.

In accordance with another aspect of the disclosure, a computing device for a payment system includes: a communicator; a memory storing one or more instructions; and a processor configured to execute the one or more instructions stored in the memory to: transmit, to a user device based on a first order, order information including information regarding the first order and a verification module caller for verifying the order information; receive, from the user device, a request to verify the order information using the verification module caller; obtain, based on the received request to verify the order information, a verification result indicating whether the first order is a valid order; and transmit the verification result to the user device.

The processor may be further configured to execute the one or more instructions to: transmit a verification result indicating a success to the user device, based on the first order being the valid order; and transmit a verification result indicating a failure to the user device, based on the first order not being the valid order.

The processor may be further configured to execute the one or more instructions to: receive, from a payment server, a first payment result with respect to the first order; obtain, based on the first payment result, payment status information indicating whether payment for the first order is completed; and change the payment status information to indicate completion of the payment based on the payment status information not indicating a payment completion status.

The processor may be further configured to execute the one or more instructions to: based the first payment result with respect to the first order being received from the payment server, control a payment request device that requested the first order to provide a notification informing about the completion of the payment.

The processor may be further configured to execute the one or more instructions to: receive, from the payment server, a second payment result with respect to the first order; obtain, based on receiving the second payment result, the payment status information with respect to the first order; and transmit, to the payment server based on the payment status information indicating a payment completion status, a request to cancel payment corresponding to the second payment result.

The processor may be further configured to execute the one or more instructions to: receive a request to cancel the first order; obtain, based on the received request to cancel the first order, payment status information with respect to the first order; and change, based on the payment status information indicating a payment completion status, the payment status information to indicate a scheduled cancellation status.

The processor may be further configured to execute the one or more instructions to, based on receiving the request to cancel the first order, control a payment request device that cancels the first order to provide a notification informing about that cancellation of payment is in progress.

The processor may be further configured to execute the one or more instructions to: receive, from a payment server, a first payment result with respect to the first order; obtain, based on the received first payment result, the payment status information with respect to the first order; and transmit, to the payment server based on the obtained payment status information indicating the scheduled cancellation status, a request to cancel payment corresponding to the first payment result.

Based on a result of canceling the payment corresponding to the first payment result being received, the processor may be further configured to execute the one or more instructions to control a notification informing about completion of cancellation of the payment to be provided.

In accordance with another aspect of the disclosure, a non-transitory computer-readable recording medium stores a program executable by a processor to perform: transmitting, to a user device based on a first order, order information including information regarding the first order and a verification module caller for verifying the order information; receiving, from the user device, a request to verify the order information using the verification module caller; obtaining, based on the received request to verify the order information, a verification result indicating whether the first order is a valid order; and transmitting the verification result to the user device.

The program may be executable by the processor to further perform: receiving, from a payment server, a first payment result with respect to the first order; obtaining, based the first payment result, payment status information indicating whether payment for the first order is completed; and changing the payment status information to indicate completion of the payment based on the payment status information not indicating a payment completion status.

The program may be executable by the processor to further perform, based on receiving the first payment result with respect to the first order from the payment server, controlling a payment request device that requested the first order to provide a notification informing about the completion of the payment.

The program may be executable by the processor to further perform: receiving, from the payment server, a second payment result with respect to the first order; obtaining, based on receiving the second payment result, the payment status information with respect to the first order; and transmitting, to the payment server based on the payment status information indicating a payment completion status, a request to cancel payment corresponding to the second payment result.

The program may be executable by the processor to further perform: receiving a request to cancel the first order; obtaining, based on the received request to cancel the first order, payment status information with respect to the first order; and changing, based on the payment status information not indicating a payment completion status, the payment status information to indicate a scheduled cancellation status.

The program may be executable by the processor to further perform: receiving, from the payment server, a first payment result with respect to the first order; obtaining, based on the received first payment result, the payment status information with respect to the first order; and transmitting, to the payment server based on the obtained payment status information indicating the scheduled cancellation status, a request to cancel payment corresponding to the first payment result.

In accordance with another aspect of the disclosure, a method for verifying validity of an order using multiple devices, includes: receiving, by a second user device and from a payment server or a first server distinct from the payment server, order information including information regarding a first order submitted by a first user device and a verification module caller for verifying the order information; transmitting, to the first server, a request to verify the order information using the verification module caller; and receiving, from the first server based on the transmitted request to verify the order information, a verification result indicating whether the first order is a valid order.

The method may further including transmitting the verification result to the payment server.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a user making a payment using a payment request device and a payment process device through a payment agent server, according to an embodiment;

FIG. 2 illustrates a payment system according to an embodiment;

FIG. 3 is a flowchart of a method of providing a payment system by a first server, according to an embodiment;

FIG. 4 is a diagram illustrating a verification of an order through a verification module according to an embodiment;

FIG. 5 is a flowchart illustrating operations performed among a first server, a payment process device, and a payment server, according to an embodiment;

FIG. 6 is a flowchart illustrating operations performed among a first server, a payment process device, and a payment server when a duplicate payment result is received, according to an embodiment;

FIG. 7 is a flowchart illustrating operations performed among a first server, a payment process device, and a payment server when a cancel order is received, according to an embodiment; and

FIG. 8 is a detailed block diagram of an electronic device according to an embodiment.

### DETAILED DESCRIPTION

Some terms used in the present disclosure will be briefly described and then one or more embodiments will be described in detail below.

In the disclosure, general terms that have been widely used are selected, when possible, in consideration of functions of the disclosure, but non-general terms may be selected according to the intentions of ordinarily skilled artisans in the this art, precedents, new technologies, etc. Some terms may be arbitrarily chosen by the present applicant, and in this case, the meanings of these terms will be explained in corresponding parts of the disclosure in detail. Thus, the terms used herein should be defined not based on the names thereof but based on the meanings thereof and the whole context of the disclosure.

It will be understood that when a part is referred to throughout the specification as “including” an element, the part may include other elements as well unless stated otherwise. Terms such as “unit,” “module,” and the like, when used herein, represent units for processing at least one function or operation, which may be implemented by hardware, software, or a combination of hardware and software.

An application refers to software that is executed in an operating system (OS) for an electronic device, an operating system (OS) for a computer, or a mobile OS for a portable device and used by a user. An application (e.g., an application for setting of a Peer-to-Peer (P2P) operation channel) according to an embodiment may be understood as software executable in electronic devices, portable devices, or external devices (e.g., a server, etc.) connected to a portable device. An application (e.g., an application for setting of a P2P operation channel) according to an embodiment may be understood as software for control of an external device (e.g., a server or a portable device) connected to an installed electronic device wirelessly or via wire. The software corresponding to the setting of the P2P operation channel according to an embodiment may be embodied as an OS, an application, firmware, or the like.

Hereinafter, embodiments of the disclosure will be described in detail with reference to the accompanying drawings, so that the embodiments of the disclosure may be easily implemented by those of ordinary skill in the art. However, the disclosure may be embodied in many different forms and is not limited to embodiments set forth herein. For clarity, like components are denoted by like reference numerals throughout the specification.

Throughout the specification, the term “user” refers to a person who controls a function or operation of a device, and may include an administrator or installer.

Throughout the disclosure, expressions such as “at least one of a, b or c” and “at least one of a, b and c” indicate only a, only b, only c, both a and b, both a and c, both b and c, all of a, b, and c, or variations thereof.

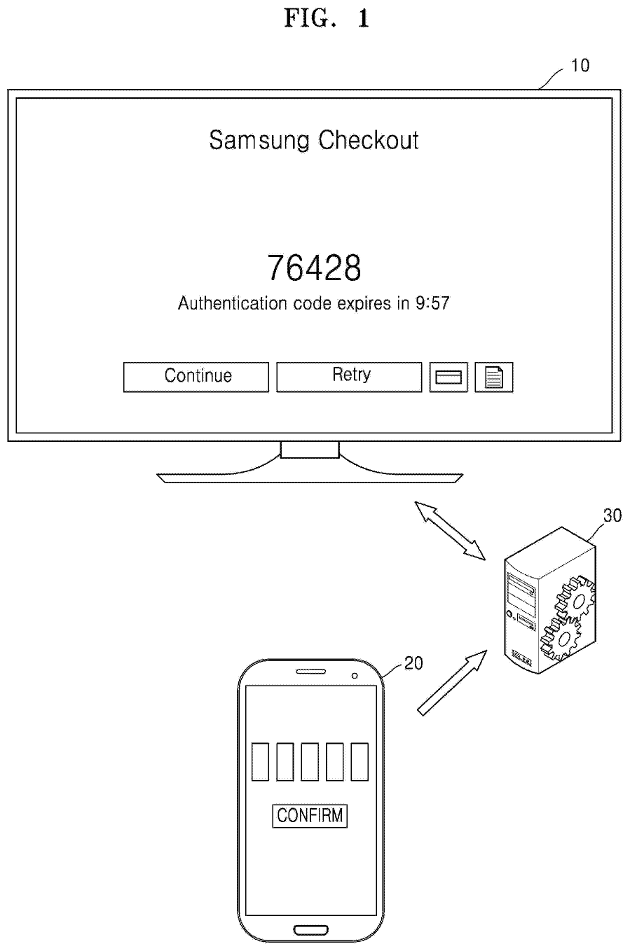

FIG. 1 is a diagram illustrating a user making a payment using a payment request device 10 and a payment process device through a payment agent server, according to an embodiment.

Referring to FIG. 1, a payment request device 10 and a payment process device 20 are devices capable of receiving a payment service through a payment server 30. In detail, the payment request device 10 refers to a device that directly receives a service order or a request to order an item from a user and directly receives a payment request corresponding to the order. The payment process device 20 refers to a device capable of executing an application or a program module for directly proceeding with the payment via the payment server 30 or a financial company server. The payment server 30 may include a server operated by a payment agent that provides a payment agent service for a card company, a bank, and the like. Alternatively, the payment server 30 may include a server directly operated by a card company, a bank, or the like.

Here, the order includes all actions of a user requesting an item to be offered in return for paying a predetermined amount. Examples of the item ordered by the user may include all services and items that are purchasable by users online, such as applications, content in games, video-on-demand (VOD) content, monthly-subscription content, media content, text content, services or items sold on online stores, etc.

The payment request device 10 may be, but is not limited to, a smart TV, a smart phone, a network sound bar, a head-mounted display (HMD), a head-up display (HUD), a wearable device, a tablet personal computer (PC), a PC, a laptop computer, a global positioning system (GPS) device, a digital broadcasting terminal, a navigation device, a kiosk, a digital camera, or another mobile or non-mobile computing device. Furthermore, the payment request device 10 may a virtual reality (VR) device having a communication function and a data processing function and providing a VR image, an augmented reality (AR) device providing an AR image, a watch, glasses, a hairband, or a ring.

The payment process device 20 may be any electronic device available to use a payment service, when authenticated as a user's own device. Various methods, such as biometrics authentication, user password authentication, multi-step authentication, and an authentication password input, may be used to authenticate whether the payment process device 20 is the user's own device. For example, the payment server 30 may transmit a short message service (SMS) message including a uniform resource locator (URL) for user authentication to the payment process device 20. The user may proceed with user authentication and payment through a user interface of the payment process device 20 connected based on the URL.

In the embodiment illustrated in FIG. 1, the payment server 30 may transmit an authentication password to the payment request device 10, and the payment request device 10 may provide the authentication password in the form of visual content, audio content, a motion, or the like, so that the authentication password may be identified by the user. The user may complete the user authentication by inputting the identified authentication password via the user interface provided in the payment process device 20. When the user authentication is completed, payment for the user's order may proceed through the payment server 30 using an application or a program module executed in the payment process device 20.

While the payment proceeds according to a payment request from the user, a function of canceling the payment is provided for the user's convenience. A request to cancel the payment from the user is transmitted to the payment server 30 via the payment request device 10 or the payment process device 20. The time when the payment server 30 processes or cancels the payment in response to the payment request or the request to cancel the payment does not exactly coincide with the time when the processing or canceling of the payment is identified by the payment request device 10 or the payment process device 20. Accordingly, there is a possibility that a duplicate payment is made inadvertently by the user or the payment is not canceled.

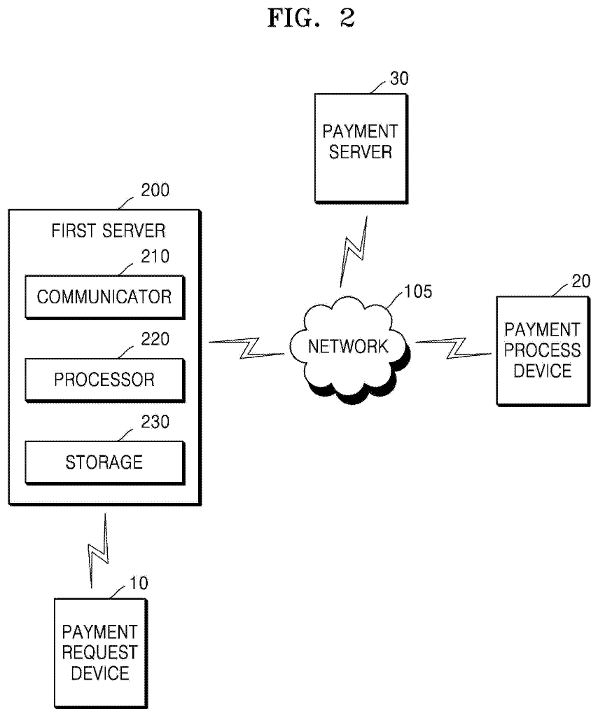

FIG. 2 illustrates a payment system according to an embodiment of the disclosure.

Referring to FIG. 2, a first server 200, a payment process device 20, and a payment server 30 may be connected via a network 105 to configure a payment system.

The first server 200 is a server device capable of processing an order according to an order request from a user and a payment according to a payment request from a user through a payment request device 10 and informing the user of a process for processing the payment via the payment request device 10. The first server 200 is a server device that stores or provides a program or an application for operating a payment module in the payment request device 10.

The network 105 may refer to a connection established (or formed) using a certain communication method, or a communication network for transmitting or receiving data between user devices or between a user device and a service provider server.

The communication method may include a communication method such as communication established using a certain communication standard, a certain frequency band, a certain protocol, or a certain channel. For example, the communication method may include a communication method performed using at least one of Bluetooth, Bluetooth low energy (BLE), Wi-Fi, Zigbee, 3rd Generation (3G), Long Term Evolution (LTE), 5th Generation (5G), or ultrasound, and may include all of a long-distance communication method, a short-distance communication method, a wireless communication method and a wired communication method. However, it is understood that these are just examples, and the communication method is not limited thereto.

In an embodiment, the long-distance communication method may refer to a communication method by which a device may establish communication regardless of the distance. For example, the long-distance communication method may refer to a method by which two devices communicating with each other via a repeater, such as an access point (AP), are capable of communicating with each other even beyond a certain distance, and may include a communication method, such as a short message service (SMS) or a telephone, using a cellular network (3G or LTE). The short-distance communication method may refer to a communication method by which a device (a terminal or a server) is capable of establishing communication only within a certain range, and may include, for example, Bluetooth, near-field communication (NFC), or the like. However, it is understood that embodiments are not limited thereto.

Referring to FIG. 2, the first server 200 according to an embodiment may include a communicator 210, a processor 220, and a storage 230.

The communicator 210 may transmit and receive data or signals to or receive data or signals from the payment process device 20 and the payment server 30 via the network 105, under control of the processor 220.

For example, the communicator 210 may include one or more elements establishing communication via a local-area network (LAN), a wide-area network (WAN), a value-added network (VAN), a mobile radio communication network, a satellite communication network, or a combination thereof.

In an embodiment, the processor 220 may execute one or more programs stored in the storage 230. The processor 220 may include a single core, dual cores, triple cores, quad cores, or multiple cores. Alternatively, the processor 220 may include a plurality of processors.

The processor 220 may execute one or more instructions to transmit order information including information regarding a first order and a verification module caller for verifying the order information to a user device, in response to the first order. The processor 220 may receive a request to verify the order information using the verification module caller from the user device, and obtain a verification result indicating whether the first order is a valid order, in response to the request. In addition, the processor 220 may control the verification result to be transmitted to the user device.

In an embodiment, the order information may include at least one of a unique order number, order requester information, amount information, information regarding an item ordered, or order status information related to the first order.

Here, the unique order number may include a hashed order number for the first order. In addition, the unique order number may include an order number provided by the seller of the item. The order status information may be obtained by calling a verification module by using the verification module caller and providing the unique order number to the verification module.

The processor 220 may transmit a verification result indicating a success to the user device when (e.g., based on) the first order is a valid order and transmit a verification result indicating a failure to the user device when (e.g., based on) the first order is not an invalid order.

Furthermore, the processor 220 may receive a first payment result with respect to the first order from the payment server 30, obtain payment status information indicating whether payment for the first order is completed in response to (e.g., based on) the first payment result, and change the payment status information to indicate completion of the payment when the payment status information does not indicate a payment completion status.

The storage 230 may store various data, a program, or an application for driving and controlling the first server 200. The program stored in the storage 230 may include one or more instructions. The storage 230 may store one or more OSs, application programs, program modules, data, or any other information. The storage 230 may be part of the first server 200 or be connected to the first server 200.

Alternatively, the storage 230 may be part of one or more other computing devices, such as a database, a cloud storage device, and the like, which communicate with the first server 200. In addition, the storage 230 may include a verification module for verifying the order information.

The payment system illustrated in FIG. 2 is capable of confirming the reliability of the order by verifying the requested payment before charging for the order. Accordingly, the payment may be made only when the order information is correct, thereby improving the stability of the payment system.

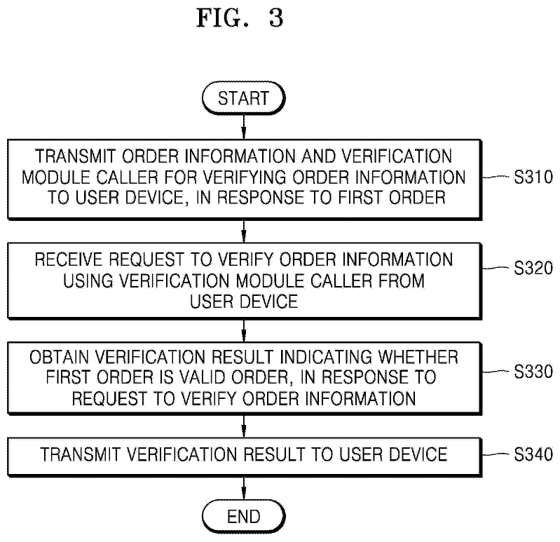

FIG. 3 is a flowchart of a method of providing a payment system by a first server 200, according to an embodiment.

Referring to FIG. 3, in operation S310, the first server 200 may transmit order information and a verification module caller for verifying the order information to a user device, in response to (e.g., based on) a first order.

The transmitting of the order information and the verification module caller to the user device by the first server 200 in response to the first order includes transmitting the order information and the verification module caller to a payment server by the first server 200 after a first order request is received.

The order information may include at least one of a unique order number, order requester information, amount information, information regarding an item ordered, or order status information related to the first order.

According to an embodiment, the user device may include the payment process device 20.

In operation S320, the first server 200 may receive a request to verify the order information using the verification module caller from the user device.

The verification module caller may include a URL for calling a verification module to verify the reliability of the order information.

In operation S330, the first server 200 may obtain a verification result indicating whether the first order is a valid order, in response to (e.g., based on) the request to verify the order information.

In operation S340, the first server 200 may transmit the verification result to the user device.

Based on the verification result transmitted to the user device in operation S340, the user device may request the payment server to make the payment.

According to an embodiment, the verification result confirming the reliability of the order information may be received before charging for the order, so that the reliability of the order information may be improved and the stability of the payment system may be improved.

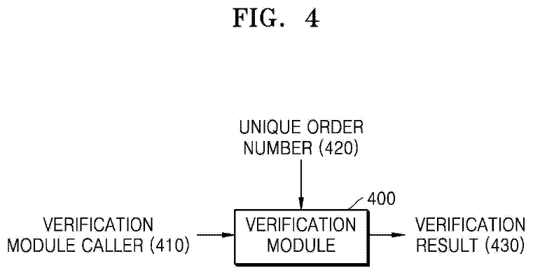

FIG. 4 is a diagram illustrating verification of an order through a verification module 400 according to an embodiment.

Referring to FIG. 4, a verification result 430 may be obtained by calling a verification module 400 by using a verification module caller 410, and providing a unique order number 420 (or identifier) to the verification module 400.

For example, the verification module 400 may include an application programming interface (API) that includes a program for verifying an order.

Furthermore, the verification module caller 410 may include a URL or an openURL to call the API. The verification module 400 may be stored in the first server 200 or separately stored in a database outside the first server 200.

The unique order number 420 may be a unique number assigned to a user's order. The first server 200 may identify the user's order, based on the order unique number 420. For example, the unique order number 420 may include an order number provided by a seller of an item. In this case, when the user purchases a certain item from, by way of example, an online shopping mall or website and a purchase number is provided from the online shopping mall, the unique order number 420 may include the purchase number provided from the online shopping mall. Alternatively, the unique order number 420 may include a hashed order number for the first order.

The verification result 430 may be a result indicating whether the first order is a valid order. For example, the verification result 430 may indicate a verification success or a verification failure.

For example, the verification result 430 may be determined based on payment status information. The payment status information includes information indicating whether a status of the first order is a payment completion status, an unsettled status, a cancellation status, or the like. The verification result 430 may be a verification success when (e.g., based on) the status of the first order is the payment completion status and may be a verification failure when (e.g., based on) the status of the first order is the unsettled status. In addition, the verification result 430 may be determined based on order requester information. The order requester information may include information indicating whether the user who is currently requesting payment is a member or a user who is permitted to make an order request or a member or a user who is not permitted to make an order request.

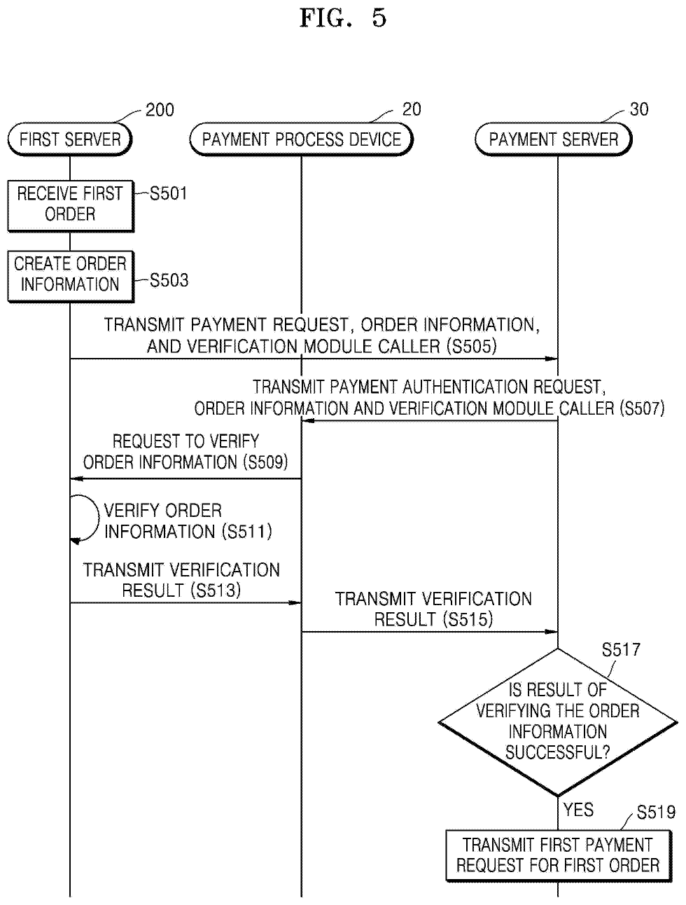

FIG. 5 is a flowchart illustrating operations performed among a first server 200, a payment process device 20, and a payment server 30, according to an embodiment.

A first server 200 may be a device, for a payment system, which operates in connection with a user's payment request device 10. A payment process device 20 refers to a device capable of executing an application or a program module for directly proceeding with the payment via a payment server 30 or a financial company server. Alternatively, the payment server 30 may be a server operated by a payment agent that provides a payment agent service for a financial institution such as a card company or a bank, and may include a server connected to a financial company server to provide a payment service.

Referring to FIG. 5, in operation S501, the first server 200 may receive a first order via the user's payment request device 10.

In operation S503, the first server 200 may create order information including information regarding the first order.

In operation S505, the first server 200 may transmit a payment request, the order information, and a verification module caller to the payment server 30.

In operation S507, the payment server 30 may transmit a payment authentication request to the payment process device 20. The payment server 30 may transmit the order information and the verification module caller to the payment process device 20, together with the payment authentication request. Here, the payment process device 20 is a device of the user who requests the first order and may be a predetermined user device.

In operation S509, the first server 200 may receive a request to verify the order information using the verification module caller from the payment process device 20. For example, the first server 200 may call a verification module of the first server 200 by using the verification module caller.

In operation S511, the first server 200 may verify the order information in response to the request to verify the order information. The first server 200 may obtain a verification result indicating whether the first order is a valid order as a result of verifying the order information by using a verification module.

In operation S513, the first server 200 may transmit the verification result to the payment process device 20. According to another embodiment, the first server 200 may transmit the verification result to the payment server 30 or to both the payment process device 20 and the payment server 30.

In operation S515, the payment process device 20 may transmit the verification result to the payment server 30.

In operation S517, the payment server 30 may identify whether the result of verifying the order information is successful or not.

In operation S519, when it is identified in operation S517 that the result of verifying the order information is successful, the payment server 30 may transmit a first payment request for the first order to an external server. Examples of the external server may include a server of a credit card company and a server of a financial company.

The first server 200 may display a process of processing the order and the payment to the user via the payment request device 10.

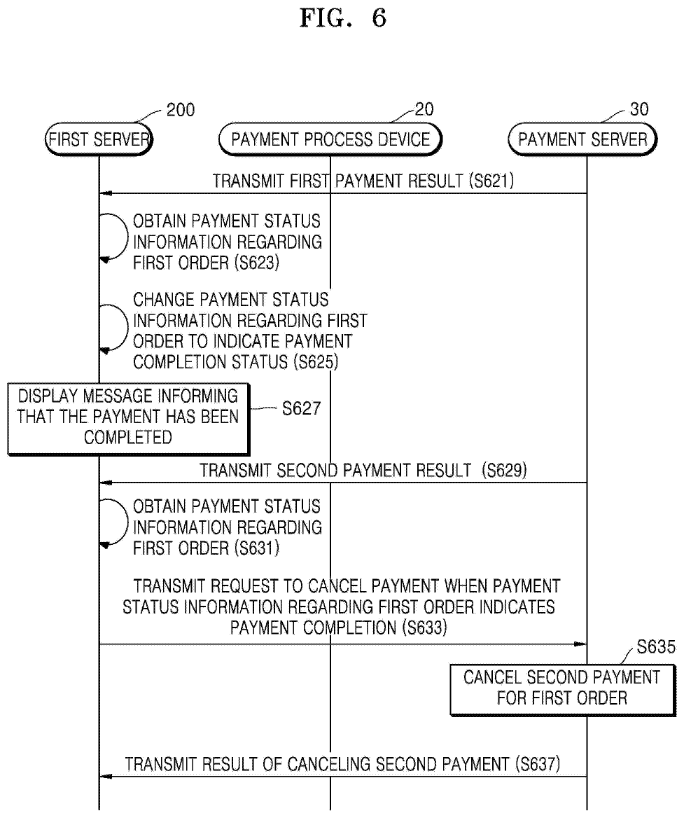

FIG. 6 is a flowchart illustrating operations performed among a first server 200, a payment process device 20, and a payment server 30 when a duplicate payment result is received, according to an embodiment.

In operation S621, a payment server 30 may transmit a first payment result to a first server 200 when (e.g., based on) first payment for a first order is completed.

In operation S623, the first server 200 may obtain payment status information indicating whether or not payment for the first order is completed, in response to, or based on, the first payment result with respect to the first order. The payment status information may include unsettled status information or payment completion status information.

In operation S625, when the payment status information does not indicate the payment completion status, the first server 200 may change the payment status information to indicate the payment completion status.

In operation S627, the first server 200 may control a payment request device 10 to display that the payment has been completed. Furthermore, the first server 200 may control the payment request device 10 to provide a notification indicating the completion of the payment.

In operation S629, the first server 200 may receive a second payment result with respect to the first order from the payment server 30. The second payment result may be a duplicate payment result due to a computational error or a duplicate payment request from a user.

In operation S631, the first server 200 may obtain payment status information indicating whether or not payment for the first order is completed, in response to the second payment result with respect to the first order.

In operation S633, when the payment status information of the first order indicates the payment completion status, the first server 200 may transmit a request to cancel the payment to the payment server 30.

In operation S635, the payment server 30 may cancel the payment corresponding to the second payment result with respect to the first order.

In operation S637, the payment server 30 may transmit a result of canceling the payment corresponding to the second payment result to the first server 200.

According to an embodiment, the first server 200 may confirm whether a duplicate payment has been made by checking payment status information after receiving a payment result. Furthermore, when receiving the payment result, the first server 200 may change the payment status information to indicate payment completion so as to prevent a duplicate payment.

In addition, in a case in which a duplicate payment result is received when the payment status information indicates payment completion, the first server 200 may cancel the payment by automatically transmitting an order cancellation request to the payment server 30.

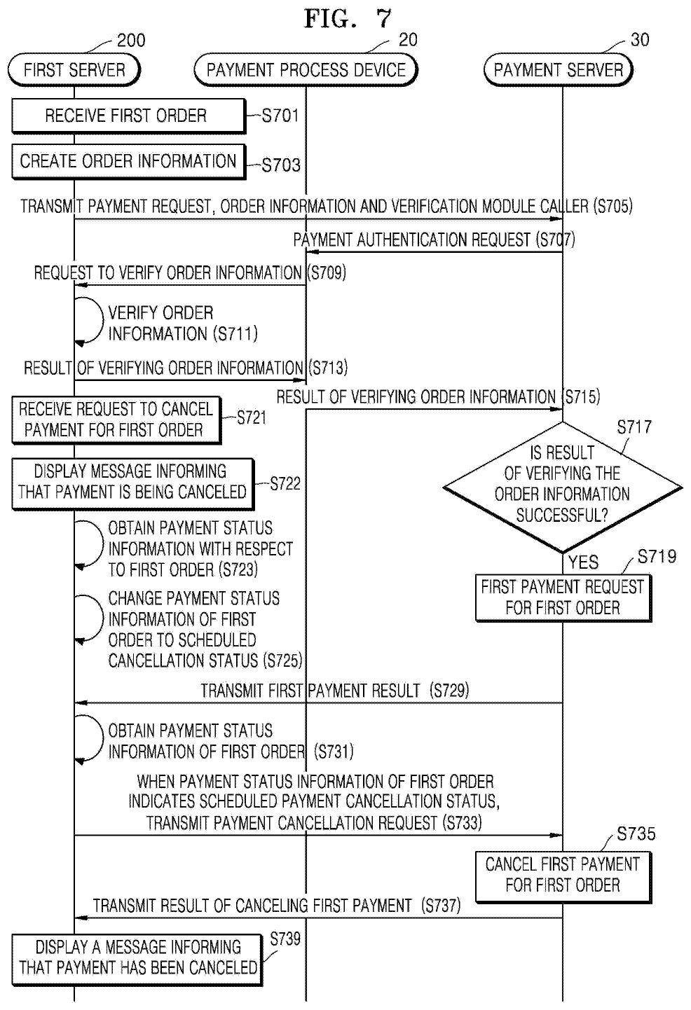

FIG. 7 is a flowchart illustrating operations performed among a first server, a payment process device, and a payment server when a cancellation order is received, according to an embodiment.

Referring to FIG. 7, in operation S701, a first server 200 may receive a first order via a user's payment request device 10.

In operation S703, the first server 200 may create order information including information regarding the first order.

In operation S705, the first server 200 may transmit a payment request, the order information, and a verification module caller to a payment server 30.

In operation S707, the payment server 30 may transmit a payment authentication request to a payment process device 20. The payment server 30 may transmit the order information and the verification module caller to the payment process device 20, together with the payment authentication request. Here, the payment process device 20 is a device of the user who requests the first order and may be a predetermined user device.

In operation S709, the first server 200 may receive a request to verify the order information using the verification module caller from the payment process device 20.

In operation S711, the first server 200 may verify the order information in response to the request to verify the order information. The first server 200 may obtain a verification result indicating whether the first order is a valid order as a result of verifying the order information by using a verification module.

In operation S713, the first server 200 may transmit the verification result to the payment process device 20.

In operation S715, the payment process device 20 may transmit the verification result to the payment server 30.

In operation S717, the payment server 30 may identify whether the result of verifying the order information is successful or not.

In operation S719, when (e.g., based on) it is identified in operation S717 that the result of verifying the order information is successful, the payment server 30 may transmit a first payment request for the first order to an external server. Examples of the external server may include a server of a credit card company and a server of a financial company.

In operation S721, the first server 200 may receive a request to cancel payment for the first order from the payment request device 10.

In operation S722, the first server 200 may control the payment request device 10 to display a message informing that the payment is being canceled or to provide a notification informing that the payment is being canceled, in response to the request to cancel the payment for the first order.

In operation S723, the first server 200 may obtain payment status information with respect to the first order, in response to the request to cancel the first order.

In operation S725, when the payment status information indicates an unsettled status, the first server 200 may change the payment status information of the first order to a scheduled cancellation status.

In operation S729, the first server 200 may receive a first payment result with respect to the first order from the payment server 30. The first payment result may be a payment result received after the request to cancel the first order is received from the user.

In operation S731, the first server 200 may obtain payment status information indicating whether or not payment for the first order is completed, in response to the first payment result with respect to the first order.

In operation S733, when the payment status information of the first order indicates a scheduled payment cancellation status, the first server 200 may transmit a payment cancellation request to the payment server 30.

In operation S735, the payment server 30 may cancel the payment corresponding to the first payment result with respect to the first order.

In operation S737, the payment server 30 may transmit a result of canceling the payment corresponding to the first payment result to the first server 200.

In operation S739, the first server 200 may control the payment request device 10 to display a message informing that the payment has been canceled or to provide a notification informing that the payment has been canceled, in response to the result of canceling the payment corresponding to the first payment result.

In related art systems, when a cancellation request is received in a state in which completion of payment is not confirmed, there is a possibility that the cancellation request will not be processed because it is regarded that there is no payment to be canceled. This results in inefficient use of system (e.g., processor) resources. According to an embodiment as illustrated in FIG. 7, a payment cancelation request may be processed by changing payment status information to indicate the scheduled cancellation status, so that the payment cancellation request may be automatically transmitted. As a result, for example, system resources are more efficiently used and functioning of the system devices improves.

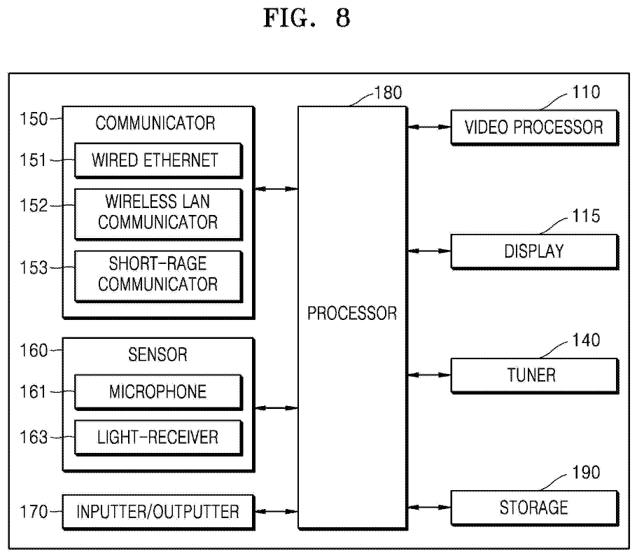

FIG. 8 is a detailed block diagram of an electronic device 100 according to an embodiment.

The electronic device 100 may correspond to the payment request device 10 described above with reference to FIGS. 1 and 2.

Referring to FIG. 8, the electronic device 100 includes a video processor 110, a display 115, a tuner 140, a communicator 150, a sensor 160, an inputter/outputter 170, a processor 180 (e.g., at least one processor), and a storage 190.

The video processor 110 processes video data received by the electronic device 100.

The display 115 displays on a screen thereof a video included in a broadcast signal received via the tuner 140, under control of the processor 180. Furthermore, the display 115 may display content (e.g., a moving image) input via the communicator 150 or the inputter/outputter 170 under control of the processor 180. The display 115 may output an image stored in the storage 190 under control of the processor 180.

The tuner 140 may select a frequency of a channel to be received by the electronic device 100 among various radio wave components by tuning the frequency of the channel by performing amplification, mixing, or resonance on a broadcast signal received via wire or wirelessly. The broadcast signal includes audio data, video and additional information (e.g., an electronic program guide (EPG)).

The tuner 140 may receive the broadcast signals in a frequency band corresponding to a channel number (e.g., cable broadcast channel No. 506) according to a user input (e.g., a control signal received from a control device, such as a channel number input, a channel up-down input, and a channel input on an EPG screen).

The tuner 140 may receive the broadcast signal from various sources such as terrestrial broadcasting, cable broadcasting, satellite broadcasting, Internet broadcasting, and the like. Alternatively, the tuner 140 may receive the broadcast signal from a source such as analog broadcasting or digital broadcasting. Decoding (e.g., audio decoding, video decoding, or additional information decoding) is performed on the broadcast signal received via the tuner 140 to divide the broadcast signal into audio data, video and/or additional information. The audio data, the video and/or the additional information may be stored in the storage 190 under control of the processor 180.

The electronic device 100 may be provided with one or more tuners 140. In an embodiment in which a plurality of tuners 140 are provided, a plurality of broadcast signals may be output to a plurality of windows constituting a multi-window screen provided on the display 115.

The tuner 140 and the electronic device 100 may be embodied together as an all-in-one device. Otherwise, the tuner 140 may be included in a separate device (e.g., a set-top box) to be electrically connected to the electronic device 100 or may be embodied as being connected to the inputter/outputter 170.

The communicator 150 may connect the electronic device 100 to an external device (e.g., an audio device) under control of the processor 180. The processor 180 may transmit (i.e., control to transmit) content to or receive (i.e., control to receive) content from an external device connected thereto via the communicator 150, download an application from the external device, or perform web browsing.

Furthermore, the communicator 150 may receive a control signal from a control device under control of the processor 180. The control signal may be embodied as a Bluetooth type, an RF signal type, or a WiFi type.

The communicator 150 may include a wired Ethernet communicator 151, a wireless LAN communicator 152 and a short-rage communicator 153, or a combination thereof according to the performance and configuration of the electronic device 100.

The wireless LAN communicator 152 may establish communication with the control device or an external device via Wi-Fi or Wi-Fi direct.

The short-range communicator 153 may establish Bluetooth communication, Bluetooth low energy (BLE) communication, infrared data association (IRDA) communication, ultra-wideband (UWB) communication, magnetic security transmission (MST), near-field communication (NFC), and the like.

A sensor 160 senses a user's voice, image, or interaction.

A microphone 161 receives the user's uttered voice. The microphone 161 may convert a received voice into an electric signal and output the electric signal to the processor 180. The user's voice may include, for example, voice corresponding to a menu or function of the electronic device 100.

The microphone 161 may be formed integrally with or separately from the electronic device 100. The microphone 161, when formed separately from the electronic device 100, may be electrically connected to the electronic device 100 via the communicator 150 or the inputter/outputter 170.

A light-receiver 163 receives an optical signal (including a control signal) from an external control device via an optical window of a bezel of the display 115 or the like. The light-receiver 163 may receive an optical signal corresponding to a user input (e.g., touching, pressing, a touch gesture, voice, or a motion) from a control device. The control signal may be extracted from the received optical signal under control of the processor 180.

It is understood that the light-receiver 163 may be omitted depending on the performance and configuration of the electronic device 100.

The inputter/outputter 170 receives a video (e.g., a moving picture), an audio signal (e.g., voice or music), and additional information (e.g., an EPG) from the outside of the electronic device 100, under control of the processor 180.

It is understood that a configuration and an operation of the inputter/outputter 170 may be variously implemented according to various embodiments.

The processor 180 controls overall operations of the electronic device 100 and the flow of signals between the internal components 110 to 190 of the electronic device 100, and processes data. The processor 180 may execute an OS and various applications stored in the storage 190 when a user input is given or a stored predetermined condition is satisfied.

The processor 180 may include a graphics processing unit (GPU) to process graphics corresponding to video. The processor 180 may be embodied as a system-on-chip (SoC) in which a core and a GPU are integrated.

The storage 190 may store various data, programs, and/or applications for driving and controlling the electronic device 100 under control of the processor 180. The storage 190 may store input/output signals or data corresponding to driving the video processor 110, the display 115, the communicator 150, the sensor 160, and the inputter/outputter 170.

The storage 190 may store a control program for control of the electronic device 100 and the processor 180, a presentation module for configuration of a display screen, and applications initially provided from a manufacturer or downloaded from the outside. In detail, the storage 190 may store resources such as JavaScript files and Extensible Mark-up Language (XML) files used in applications.

The storage 190 may include a presentation module. The presentation module is a module for configuration of a display screen. The presentation module includes a multimedia module for reproducing and outputting multimedia content, and a user interface (UI) rendering module for processing UIs and graphics. The multimedia module may include a player module, a camcorder module, a sound processing module, and the like. Accordingly, various multimedia content is reproduced to create and reproduce a screen and sound.

Furthermore, the storage 190 may store a graphical user interface (GUI) related to an application, objects (e.g., an image, text, icons, buttons, etc.) for providing the GUI, user information, documents, databases, or data related thereto.

In an embodiment of the disclosure, the term “storage” includes the storage 190, read-only memory (ROM) storing a control program for control of the electronic device 100, random access memory (RAM) storing signals or data input from the outside or used as a storage region corresponding to various operations performed by the electronic device 100, or a memory card (e.g., a micro secure digital (SD) card or a USB memory) installed in the electronic device 100. In addition, the storage 190 may include a nonvolatile memory, a volatile memory, a flash memory, a hard disk drive (HDD), or a solid-state drive (SSD).

The storage 190 may include a volume control module, a communication control module, a voice recognition module, a motion recognition module, a light-receiving module, a display control module, an audio control module, an external input control module, a power control module, a power control module of an external device connected wirelessly (e.g., via Bluetooth), a voice database (DB), or a motion database (DB). Modules and a database of the storage 190 may be embodied as software to perform a volume control function, a communication control function, a voice recognition function, a motion recognition function, a light-reception control function, an audio control function, an external input control function, a power control function, and a display control function for controlling a display of a cursor. The processor 180 may perform these functions using the software stored in the storage 190.

The electronic device 100 may be electrically connected to a separate external device (e.g., a set-top box) with a tuner. It is understood that the electronic device 100 may be embodied, for example, as an analog TV, a digital TV, a three-dimensional (3D) TV, a smart TV, a light-emitting diode (LED) TV, an organic light-emitting diode (OLED) TV, a plasma TV, or a monitor, but is not limited thereto.

At least one component may be added to or omitted from the electronic device 100 illustrated in FIG. 8 according to the performance of the electronic device 100. In addition, it will be easily understood by those of ordinary skill in the art that the positions of the components may vary according to the performance or configuration of the electronic device 100.

In the embodiments set forth herein, a user's order information is additionally verified to build an accurate payment system when the payment system is implemented using a plurality of different devices.

Embodiments set forth herein are also directed to reducing a possibility of a duplicate payment or a payment error by additionally verifying a user's order information, when the payment system is implemented using different devices, thereby reducing service operation costs incurred to respond to inquiries from customers.

A control method according to an embodiment may be embodied as a program command executable through various computer means and recorded on a computer-readable recording medium. The computer-readable recording medium may include program commands, data files, data structures, etc., solely or in combination. The program commands recorded on this computer-readable recording medium may be specially designed and configured for the disclosure or may be known and available to those of skill in the field of computer software. Examples of the computer-readable recording medium include magnetic media such as hard disks, floppy disks and magnetic tapes, optical media such as CD-ROMs and DVDs, magneto-optical media such as floptical disks, and hardware devices such as ROM, RAM, flash memory, and the like which are specifically configured to store and execute program commands. Examples of the program commands include not only machine language code prepared by a compiler, but also high-level language code executable by a computer by using an interpreter. Some embodiments may be embodied as a computer program or a computer program product including instructions, e.g., a computer program, which are executable by a computer.

In the foregoing specification, the disclosure and features thereof have been described with reference to embodiments. However, various changes and modifications may be made by those of ordinary skill in the art without departing from the scope of the disclosure defined in the following claims. Accordingly, the present specification and drawings should be considered in a descriptive sense only and not for purposes of limitation.

What is claimed is:

1. A method for verifying validity of an order using multiple devices, the method comprising:
transmitting, to a user device based on a first order, order information comprising information regarding the first order and a verification module caller for verifying the order information;
receiving, from the user device, a request to verify the order information using the verification module caller;
obtaining, based on the received request to verify the order information, a verification result indicating whether the first order is a valid order; and
transmitting the verification result to the user device.

2. The method of claim 1, wherein the transmitting the verification result to the user device comprises:
transmitting a verification result indicating a success to the user device, based on the first order being the valid order; and
transmitting a verification result indicating a failure to the user device, based on the first order not being the valid order.

3. The method of claim 1, further comprising:
receiving, from a payment server, a first payment result with respect to the first order;
obtaining, based the first payment result, payment status information indicating whether payment for the first order is completed; and
changing the payment status information to indicate completion of the payment based on the payment status information not indicating a payment completion status.

4. The method of claim 3, further comprising, based on receiving the first payment result with respect to the first order from the payment server, controlling a payment request device that requested the first order to provide a notification informing about the completion of the payment.

5. The method of claim 3, further comprising:
receiving, from the payment server, a second payment result with respect to the first order;
obtaining, based on receiving the second payment result, the payment status information with respect to the first order; and
transmitting, to the payment server based on the payment status information indicating a payment completion status, a request to cancel payment corresponding to the second payment result.

6. The method of claim 1, further comprising:
receiving a request to cancel the first order;
obtaining, based on the received request to cancel the first order, payment status information with respect to the first order; and
changing, based on the payment status information not indicating a payment completion status, the payment status information to indicate a scheduled cancellation status.

7. The method of claim 6, further comprising, based on receiving the request to cancel the first order, controlling a payment request device that cancels the first order to provide a notification informing that cancellation of payment is in progress.

8. The method of claim 6, further comprising:
receiving, from a payment server, a first payment result with respect to the first order;
obtaining, based on the received first payment result, the payment status information with respect to the first order; and
transmitting, to the payment server based on the obtained payment status information indicating the scheduled cancellation status, a request to cancel payment corresponding to the first payment result.

9. The method of claim 8, further comprising, based on a result of cancelling the payment corresponding to the first payment result being received, controlling a notification informing about completion of cancellation of the payment to be provided.

10. The method of claim 1, wherein the order information comprises at least one of a unique order number, order requester information, amount information, information regarding an item ordered, and payment status information related to the first order.

11. A computing device for a payment system, the computing device comprising:
a communicator;
a memory storing one or more instructions; and
a processor configured to execute the one or more instructions stored in the memory to:
transmit, to a user device based on a first order, order information comprising information regarding the first order and a verification module caller for verifying the order information;
receive, from the user device, a request to verify the order information using the verification module caller;
obtain, based on the received request to verify the order information, a verification result indicating whether the first order is a valid order; and
transmit the verification result to the user device.

12. The computing device of claim 11, wherein the processor is further configured to execute the one or more instructions to:
transmit a verification result indicating a success to the user device, based on the first order being the valid order; and
transmit a verification result indicating a failure to the user device, based on the first order not being the valid order.

13. The computing device of claim 11, wherein the processor is further configured to execute the one or more instructions to:
receive, from a payment server, a first payment result with respect to the first order;
obtain, based on the first payment result, payment status information indicating whether payment for the first order is completed; and
change the payment status information to indicate completion of the payment based on the payment status information not indicating a payment completion status.

14. The computing device of claim 13, wherein the processor is further configured to execute the one or more instructions to:
based the first payment result with respect to the first order being received from the payment server, control a payment request device that requested the first order to provide a notification informing about the completion of the payment.

15. The computing device of claim 13, wherein the processor is further configured to execute the one or more instructions to:
receive, from the payment server, a second payment result with respect to the first order;
obtain, based on receiving the second payment result, the payment status information with respect to the first order; and
transmit, to the payment server based on the payment status information indicating a payment completion status, a request to cancel payment corresponding to the second payment result.

16. The computing device of claim 11, wherein the processor is further configured to execute the one or more instructions to:
receive a request to cancel the first order;
obtain, based on the received request to cancel the first order, payment status information with respect to the first order; and
change, based on the payment status information indicating a payment completion status, the payment status information to indicate a scheduled cancellation status.

17. The computing device of claim 16, wherein the processor is further configured to execute the one or more instructions to:
based on receiving the request to cancel the first order, control a payment request device that cancels the first order to provide a notification informing about that cancellation of payment is in progress.

18. The computing device of claim 16, wherein the processor is further configured to execute the one or more instructions to:
receive, from a payment server, a first payment result with respect to the first order;
obtain, based on the received first payment result, the payment status information with respect to the first order; and
transmit, to the payment server based on the obtained payment status information indicating the scheduled cancellation status, a request to cancel payment corresponding to the first payment result.

19. The computing device of claim 18, wherein, based on a result of canceling the payment corresponding to the first payment result being received, the processor is further configured to execute the one or more instructions to control a notification informing about completion of cancellation of the payment to be provided.

20. A non-transitory computer-readable recording medium storing a program executable by a processor to perform:
transmitting, to a user device based on a first order, order information comprising information regarding the first order and a verification module caller for verifying the order information;
receiving, from the user device, a request to verify the order information using the verification module caller;
obtaining, based on the received request to verify the order information, a verification result indicating whether the first order is a valid order; and
transmitting the verification result to the user device.

21. A method for verifying validity of an order using multiple devices, the method comprising:
receiving, by a second user device and from a payment server or a first server distinct from the payment server, order information comprising information regarding a first order submitted by a first user device and a verification module caller for verifying the order information;
transmitting, to the first server, a request to verify the order information using the verification module caller; and
receiving, from the first server based on the transmitted request to verify the order information, a verification result indicating whether the first order is a valid order.
